(19) United States
(12) Patent Application Publication
(10) Pub. No.: US 2026/0146581 A1
(43) Pub. Date: May 28, 2026

(54) WIND TURBINE BLADE SPAR STRUCTURE AND METHOD OF ASSEMBLING WIND TURBINE BLADE USING SAME

(71) Applicant: LM Wind Power A/S, Kolding (DK)

(72) Inventor: Michael Belote, Little Rock, AR (US)

(21) Appl. No.: 19/120,574

(22) PCT Filed: Oct. 13, 2022
(86) PCT No.: PCT/US2022/046543

§ 371 Date: Apr. 11, 2025

(51) Int. Cl. F03D 1/06

(52) U.S. Cl. CPC F03D 1/0681; F03D 1/0677; F05B 2230/604

(57) ABSTRACT

A method of assembling a wind turbine blade includes providing a load-bearing spar structure having one or more locating features for locating one or more wind turbine blade segments, the load-bearing spar structure being secured to a fixture, the fixture being moveable and extendable. The method also includes at least one of moving and extending the fixture so as to at least one of move and elevate the load-bearing spar structure through an assembly line. The method also includes positioning the one or more wind turbine blade segments onto the one or more locating features of the load-bearing spar structure as the fixture is at least one of moved and extended through the assembly line. The method also includes securing the one or more wind turbine blade segments to the load-bearing spar structure.

### FIELD

The present disclosure relates generally to wind turbines, and more particularly to spar structures and methods of assembling wind turbine blades using said spar structures.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and a rotor having a rotatable hub with one or more wind turbine blades. The wind turbine blades capture kinetic energy of wind using known airfoil principles. The wind turbine blades transmit the kinetic energy in the form of rotational energy so as to turn a shaft coupling the wind turbine blades to a gearbox, or if a gearbox is not used, directly to the generator. The generator then converts the mechanical energy to electrical energy that may be deployed to a utility grid. Thus, the amount of electrical energy that can be deployed to the grid is dependent on the amount of mechanical energy that can be captured by the wind turbine. To this end, wind turbine blades have continued to increase in size, and consequently weight, to capture greater amounts of mechanical energy.

The wind turbine blades generally include a suction side shell and a pressure side shell typically formed using molding processes that are bonded together at bond lines along the leading and trailing edges of the blade. The body shell is typically reinforced using one or more structural components (e.g., opposing spar caps with a shear web configured therebetween) that engage the inner pressure and suction side surfaces of the shell halves. Many wind turbine blades often also include a leading-edge bond cap positioned at the leading edge of the wind turbine blade between the suction side and pressure side shells.

The spar caps are typically constructed of various materials, including but not limited to glass fiber laminate composites and/or carbon fiber laminate composites. The shell of the wind turbine blade is generally built around the spar caps of the blade by stacking layers of fiber fabrics in a shell mold. The layers are then typically infused together with a resin.

As wind turbine blades continue to increase in size, conventional infusion processes experience challenges for larger blade production (e.g., wind turbine blades exceeding 90 meters). Such challenges may include, for example, infusion quality issues and lengthy repair time.

Thus, modern methods for manufacturing wind turbine blades may include forming the wind turbine blades in segments. The blade segments may then be assembled to form the wind turbine blade. For example, some modern wind turbine blades have a modular panel configuration, such as those wind turbine blades described in U.S. patent application Ser. No. 14/753,137 filed Jun. 29, 2015, and entitled “Modular Wind Turbine Wind turbine blades and Methods of Assembling Same,” which is incorporated herein by reference in its entirety.

In view of the foregoing, the art is continually seeking new and improved methods for assembling wind turbine blades.

### BRIEF DESCRIPTION

Aspects and advantages of the invention will be set forth in part in the following description, or may be obvious from the description, or may be learned through practice of the invention.

In one aspect, the present disclosure is directed to a method of assembling a wind turbine blade. The method includes providing a load-bearing spar structure having one or more locating features for locating one or more wind turbine blade segments, the load-bearing spar structure being secured to a fixture, the fixture being moveable and extendable. The method also includes at least one of moving and extending the fixture so as to at least one of move and elevate the load-bearing spar structure through an assembly line. The method also includes positioning the one or more wind turbine blade segments onto the one or more locating features of the load-bearing spar structure as the fixture is at least one of moved and extended through the assembly line. The method also includes securing the one or more wind turbine blade segments to the load-bearing spar structure.

In an embodiment, the at least one of moving or extending of the fixture is accomplished via a conveyance device.

In further embodiments, the conveyance device is continuously operated through the assembly line to assemble the wind turbine blade.

In additional embodiments, the conveyance device is pulsed through the assembly line to assemble the wind turbine blade.

In other embodiments, the assembly line includes a plurality of stations, each station including a different subset of the one or more wind turbine blade segments for positioning onto the load-bearing spar structure. Moreover, in the embodiments, the method further includes assembling subsets of the one or more wind turbine blade segments onto the load-bearing spar structure at the plurality of stations and securing the subsets of the one or more wind turbine blade to the spar structure at the plurality of stations.

In still further embodiments, the method further includes feeding the subsets of the one or more wind turbine blade segments into the assembly line via one or more supply lines

In other additional embodiments, a first subset of the one or more wind turbine blade segments at a first station of the assembly line includes, at least, a blade root section. Moreover, in the embodiments, the method further includes positioning the blade root section onto the load-bearing spar structure at the first station.

In further additional embodiments, one or more intermediate subsets of the one or more wind turbine blade segments at one or more intermediate stations of the assembly line includes at least one of leading-edge segments, trailing edge segments, pressure side segments, or suction side segments. In addition, in the embodiments, the method further includes positioning the one or more intermediate subsets of the one or more wind turbine blade segments onto the load-bearing spar structure at the one or more intermediate stations.

In still other embodiments, an additional subset of the one or more wind turbine blade segments at an end station of the assembly line includes, at least, a blade tip section. Moreover, in the embodiments, the method further includes positioning the blade tip section onto the load-bearing spar structure at the end station

In yet other embodiments, the additional subset of the one or more wind turbine blade segments at the end station of the assembly line includes one or more aerodynamic blade features. In addition, in the embodiments, the method further includes positioning the one or more aerodynamic blade features onto the load-bearing spar structure at the end station.

In other embodiments, the one or more aerodynamic blade features include at least one of vortex generators, fairings, or fences.

In yet other embodiments, securing the one or more wind turbine blade segments to the load-bearing spar structure further includes bonding the one or more wind turbine blade segments to the load-bearing spar structure via one or more adhesives at the end station of the assembly line.

In still other embodiments, positioning the one or more wind turbine blade segments onto the one or more locating features of the load-bearing spar structure further includes utilizing a crane to position one or more of the one or more wind turbine blade segments onto the one or more locating features of the load-bearing spar structure.

In yet still other embodiments, the one or more locating features include at least one of grooves, protrusions, recesses, markings, indentations, or combinations thereof

In other embodiments, the load-bearing spar structure includes a first spar cap, a second spar cap, and a shear web arranged between the first and second spar caps

In further embodiments, at least one location feature of the one or more locating features is positioned on the shear web.

In another aspect, the present disclosure is directed to a kit for assembling a wind turbine blade. The kit includes a load-bearing spar structure including one or more locating features. The kit also includes a fixture supporting the load-bearing spar structure, the fixture being moveable along at least one axis and extendable about at least one axis. The kit also includes an assembly line including a plurality of stations arranged along the at least one axis and a conveyance device secured to the fixture for moving the fixture to each of the plurality of stations along the at least one axis. The kit also includes one or more wind turbine blade segments attachable to the one or more locating features of the load-bearing spar structure, the one or more wind turbine blade segments including one or more subsets of wind turbine blade segments, at least one of the subsets of the wind turbine blade segments being placed at each of the plurality of stations. The kit also includes a predetermined mapping for placing the one or more wind turbine blade segments onto the load-bearing spar structure, the predetermined mapping defining locations for each of the one or more wind turbine blade segments on the one or more locating features of the load-bearing spar structure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a wind turbine according to the present disclosure;

FIG. 2 illustrates a perspective view of an embodiment of a wind turbine blade of a wind turbine according to the present disclosure;

FIG. 3 illustrates an exploded view of the modular wind turbine blade of FIG. 2;

FIG. 4 illustrates a cross-sectional view of an embodiment of a leading-edge segment of a modular wind turbine blade according to the present disclosure;

FIG. 5 illustrates a cross-sectional view of an embodiment of a trailing edge segment of a modular wind turbine blade according to the present disclosure;

FIG. 6 illustrates a cross-sectional view of the modular wind turbine blade of FIG. 2 according to the present disclosure;

FIG. 7 illustrates a cross-sectional view of the modular wind turbine blade of FIG. 2 according to the present disclosure;

FIG. 8 illustrates a flow diagram of an embodiment of a method of joining wind turbine blade components according to the present disclosure;

FIG. 9 illustrates a cross-sectional view of an embodiment of a spar structure of a wind turbine blade according to the present disclosure;

FIGS. 10A-10E illustrate various embodiments of locating features of a spar structure according to the present disclosure;

FIGS. 11A-11B illustrate various cross-sectional views of an embodiment of a spar structure secured to a fixture capable of moving and elevating the spar structure according to the present disclosure;

FIG. 12 illustrates a top view of an embodiment of one of a plurality of stations of a manufacturing facility for manufacturing and assembling wind turbine blades according to the present disclosure, particularly illustrating a plurality of subsets of wind turbine blade segments being secured to the spar structure; and FIG. 13 illustrates a top view of an embodiment of a manufacturing facility for manufacturing and assembling wind turbine blades according to the present disclosure;

FIG. 14 illustrates a perspective view of an embodiment of a manufacturing facility of manufacturing and assembling wind turbine blades according to the present disclosure;

FIG. 15A illustrates a side, exploded view of a fairing, particularly illustrating a fairing according to the present disclosure;

FIG. 15B illustrates a top, exploded view of the fairing of FIG. 15A according to the present disclosure; and

FIG. 15C illustrates a top view of the fairing of FIGS. 15A-15B, particularly illustrating the fairing being assembled and attached to the spar structure according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present disclosure is directed to systems and methods of assembling wind turbine blades using a load-bearing spar structure and a supporting fixture, wherein the fixture is configured to move and/or elevate the spar structure as the spar structure moves through an assembly line. Thus, in an embodiment, the spar structure has various locating elements for positioning one or more wind turbine blade segments thereon. As such, in an embodiment, the spar structure serves as both a structural component of the wind turbine blade and an assembly guide. Accordingly, as the spar structure moves through the assembly line, the wind turbine blade segments can be easily positioned thereon to assemble the wind turbine blade. As such, systems and methods of the present disclosure can improve overall efficiency of wind turbine blade manufacturing.

Furthermore, in an embodiment, the manufacturing facility for housing the systems of the present disclosure can be set up and shut down quickly, at low-cost. In an embodiment, standard warehouses at ports can be leased during the assembly period. Moreover, in an embodiment, the manufacturing facility can be built around the conveyance/moving assembly line, where the wind turbine blades are continuously moved through the manufacturing facility and are assembly as they progress toward the exit. As such, in an embodiment, the manufacturing facility can be focused on assembling and finishing already-green-tagged subcomponents.

For example, in an embodiment, subcomponents manufactured offsite can be loaded into the aforementioned manufacturing facility to either side of the moving assembly line. Accordingly, in an embodiment, the manufacturing facility may be up to about five (5) times the length of a finished wind turbine blade. Furthermore, in an embodiment, side areas can be run as Kanbans on a just-in-time (JIT) system, such that the moving assembly line does not starve during the assembly process. In another embodiment, systems and methods of the present disclosure may include a stoplight system for rapid responses to issues and/or problems. Systems and methods of the present disclosure are further capable of assembling multiple wind turbine blades at the same time, e.g., such as around seven wind turbine blades (or more or less) being in work-in-progress at all times. In such embodiments, as one wind turbine blade is completed, a blade root of another blade may be attached to the moving assembly line to make the process continuous.

The system and methods may provide various advantages in the field of assembling wind turbine blades. For example, one of the advantages of having a load-bearing spar structure is the ability to create manufacturing flow in operation. In particular, if a spar cap is used instead, then the spar cap cannot serve as a chassis. As a result, manufacturing is performed more or less in a static environment—i.e., the necessary parts are brought to the same location and assembled within a mold. This requires use of shared equipment (like cranes), shared floorspace, and generates inefficiencies. In contrast, a flowing or moving production line, enabled by a load-bearing spar structure, allows each station to be ideally optimized for the production at this point.

Thus, the system and method may provide increased overall manufacturing efficiencies by reducing various forms of waste (such as: overproduction—i.e., making more subassemblies than needed or earlier than needed; starvation—i.e., not having a part ready when needed; excess movement—i.e., having to crisscross the building rather than working in a dedicated area; or waiting—i.e., using shared cranes and equipment that are currently in use elsewhere in the building). Further, using load-bearing spar structures as transportable moving chassis lines enables access to methods of lean manufacturing such as described hereinbelow.

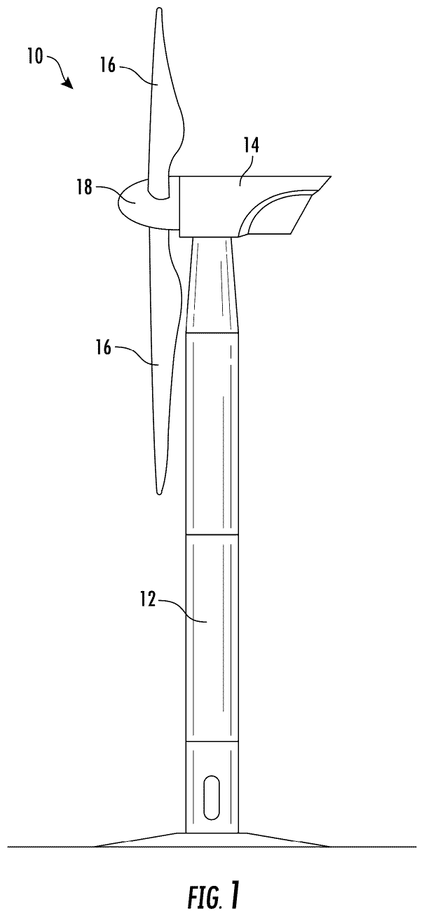

Referring now to the drawings, FIG. 1 illustrates a perspective view of an embodiment of a wind turbine 10 according to the present disclosure. As shown, the wind turbine 10 includes a tower 12 with a nacelle 14 mounted thereon. A plurality of wind turbine blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application that involves the assembly of wind turbine blades.

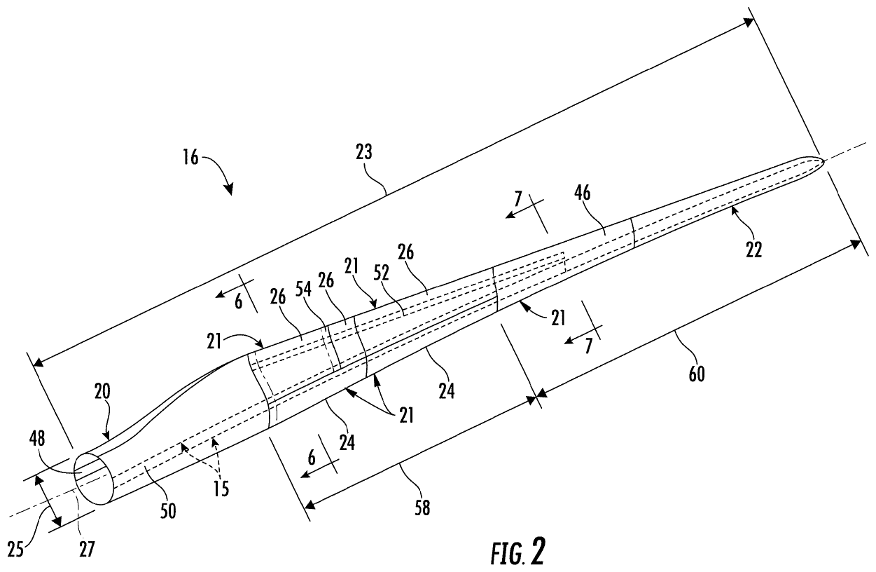

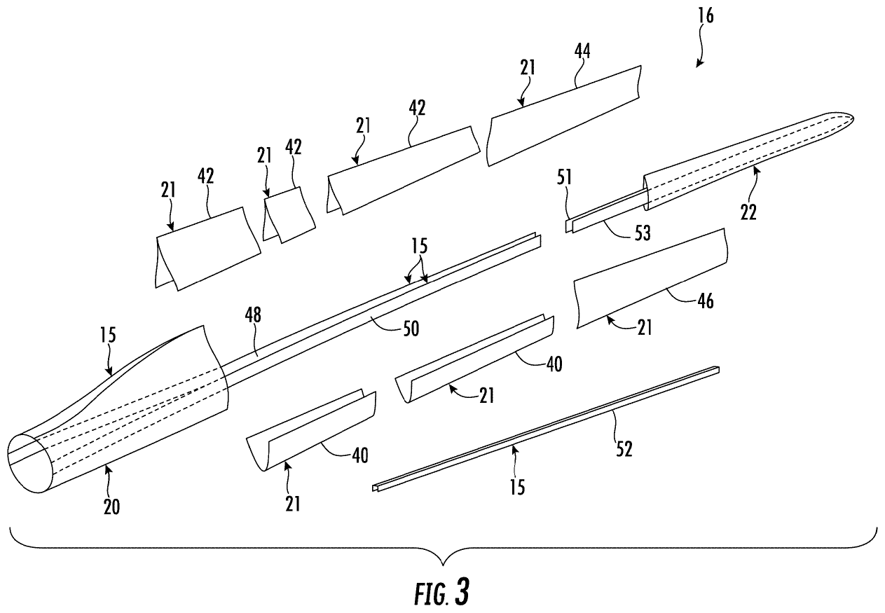

Referring now to FIGS. 2 and 3, various views of a wind turbine blade 16 according to the present disclosure are illustrated. As shown, the illustrated wind turbine blade 16 has a segmented or modular configuration. It should also be understood that the wind turbine blade 16 may include any other suitable configuration now known or later developed in the art. As shown, the modular wind turbine blade 16 includes a main blade structure 15 and at least one blade segment 21 secured to the main blade structure 15. More specifically, as shown, the wind turbine blade 16 includes a plurality of blade segments 21.

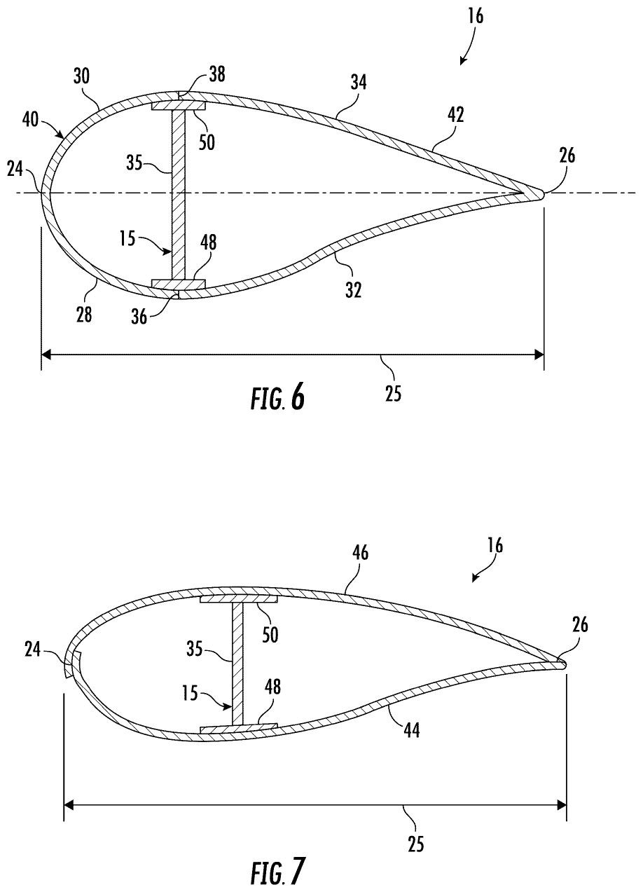

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the wind turbine blade 16. Further, the blade root section 20 is configured to be mounted or otherwise secured to the rotor 18 (FIG. 1). In addition, as shown in FIG. 2, the wind turbine blade 16 defines a span 23 that is equal to the total length between the blade root section 20 and the blade tip section 22. As shown in FIGS. 2 and 6, the wind turbine blade 16 also defines a chord 25 that is equal to the total length between a leading edge 24 of the wind turbine blade 16 and a trailing edge 26 of the wind turbine blade 16. As is generally understood, the chord 25 may generally vary in length with respect to the span 23 as the wind turbine blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the wind turbine blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi-jointed blade segment, a J-shaped blade segment, or similar.

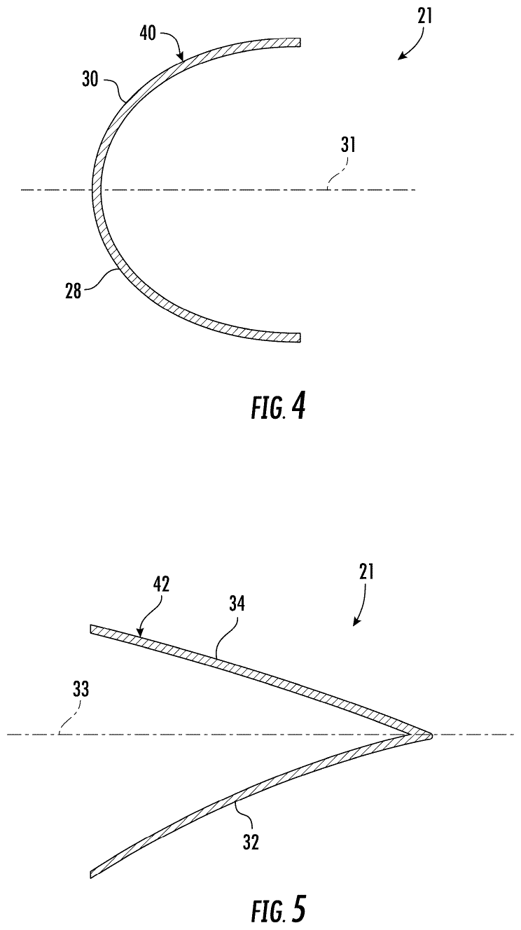

More specifically, as shown in FIG. 4, the leading-edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading-edge segment 40 and the aft pressure side surface 32 of the trailing edge segment 42 generally define a pressure side surface of the wind turbine blade 16. Similarly, the forward suction side surface 30 of the leading-edge segment 40 and the aft suction side surface 34 of the trailing edge segment 42 generally define a suction side surface of the wind turbine blade 16. In addition, as particularly shown in FIG. 6, the leading-edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the wind turbine blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015, entitled “Blade Root Section for a Modular Wind turbine blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the wind turbine blade 16. Further, the blade root spar caps 48, 50 may be configured to align with the blade tip spar caps 51, 53. Thus, the spar caps 48, 50, 51, 53 may generally be designed to control the bending stresses and/or other loads acting on the wind turbine blade 16 in a generally span-wise direction (a direction parallel to the span 23 of the wind turbine blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the wind turbine blade 16. For example, the structural component 52 may be configured according to U.S. application Ser. No. 14/753,150 filed Jun. 29, 2015, entitled “Structural Component for a Modular Wind turbine blade” which is incorporated herein by reference in its entirety. More specifically, the structural component 52 may extend any suitable distance between the blade root section 20 and the blade tip section 22. Thus, the structural component 52 is configured to provide additional structural support for the wind turbine blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

Referring generally to FIGS. 8-15, systems and methods of assembling a wind turbine blade, such as the wind turbine blade 16, according to the present disclosure are illustrated. Referring particularly to FIG. 8, a flow diagram of an embodiment of a method 100 of assembling the wind turbine blade 16 is illustrated. Although FIG. 8 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (102), the method 100 includes providing a load-bearing spar structure having one or more locating features for locating one or more wind turbine blade segments thereon. Furthermore, the load-bearing spar structure is secured to a fixture that is moveable and/or extendable. Moreover, in an embodiment, the wind turbine blade segments may be any suitable wind turbine blade segments, such as those described herein, including but not limited to a trailing edge segment, a leading-edge segment, a pressure side segment, a suction side segment, or similar. Further, in an embodiment, and as will be described in more detail herein, the locating features may be grooves, protrusions, recesses, markings, indentations, or combinations thereof.

Referring still to FIG. 8, as shown at (104), the method 100 includes moving and/or extending the fixture so as to move and/or elevate the load-bearing spar structure through an assembly line. For example, the movement or extension of the fixture may be accomplished via a conveyance device, such as a conveyor belt or one or more rolling elements (such as wheels and/or rollers). In further embodiments, the conveyance device may also be a tow, and/or a robotic device or robotic arm. In additional embodiments, the conveyance device may be continuously operated so as to continuously move the spar structure through the assembly line as the wind turbine blade is being assembled thereon. In another embodiment, the conveyance device may be pulsed so as to pulse the spar structure through the assembly line as the wind turbine blade is being assembled thereon. Moreover, in an embodiment, if the conveyance device is continuously operated, the spar structure may be continuously progressed through the assembly line, while the wind turbine blade segments are continuously being added to the spar structure so as to streamline the assembly process.

Thus, as the fixture is moved and/or extended through the assembly line, as shown at (106), the method 100 further includes positioning the wind turbine blade segments onto the locating features of the load-bearing spar structure. For example, in an embodiment, positioning of the wind turbine blade segments on the locating features may be accomplished manually or via a forklift, robotic device, crane, etc.

Referring still to FIG. 8, as shown at (108), the method 100 includes securing the wind turbine blade segments to the load-bearing spar structure. For example, in an embodiment, the wind turbine blade segments may be secured to the spar structure by bonding the wind turbine blade segment(s) to the spar structure via an adhesive. In another embodiment, the wind turbine blade segments may be secured to the spar structure using one or more fasteners.

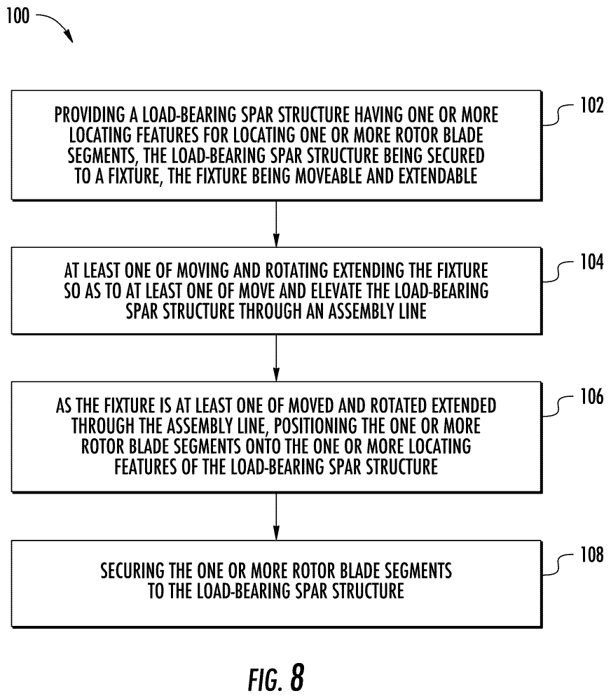

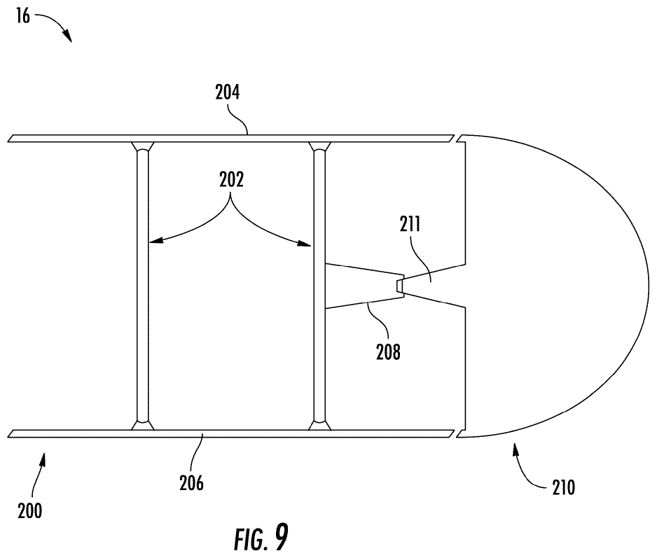

The method of FIG. 8 can be better understood with respect to FIGS. 9-15. In particular, referring now to FIG. 9, a cross-sectional view of an embodiment of a spar structure 200 that can be used in the assembly method 100 of FIG. 8 according to the present disclosure is illustrated. Moreover, such embodiments may form a kit which can be used to assemble a wind turbine blade using the assembly method 100 of FIG. 8 or using the embodiments and features described herein. As shown, in an embodiment, the spar structure 200 may include one or more shear web members 202, a first spar cap 204, and an opposing second spar cap 206. In particular embodiments, as shown, the spar structure 200 may include two shear web members 202. In further embodiments, the spar structure 200 may include more than two or less than two shear web members 202.

In addition, as shown, the spar structure 200 may include one or more locating features 208 positioned on one or more of the shear web members 202 for positioning one or more wind turbine blade segments 210 thereto. In further embodiments, the locating feature(s) 208 may also be positioned at any other suitable location on the spar structure 200. In further embodiments, the wind turbine blade segments 210 described herein may include one or more corresponding locating feature(s) 211. Accordingly, in an embodiment, the locating features 208, 211 may provide a predetermined mapping for placing the one or more wind turbine blade segments 210 onto the spar structure 200. In such embodiments, the predetermined mapping defines locations for each of the wind turbine blade segments 210 on the spar structure 200.

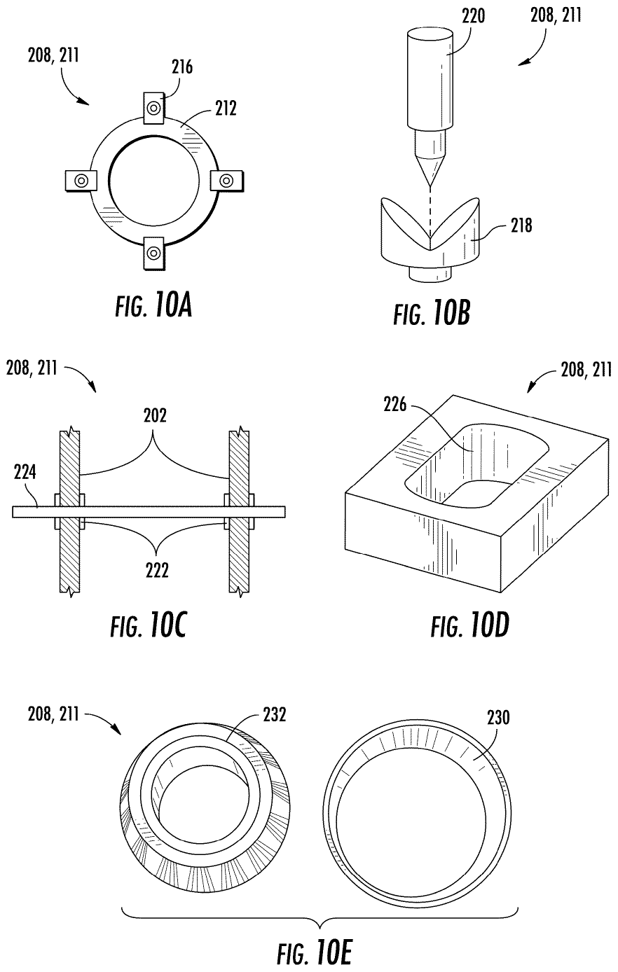

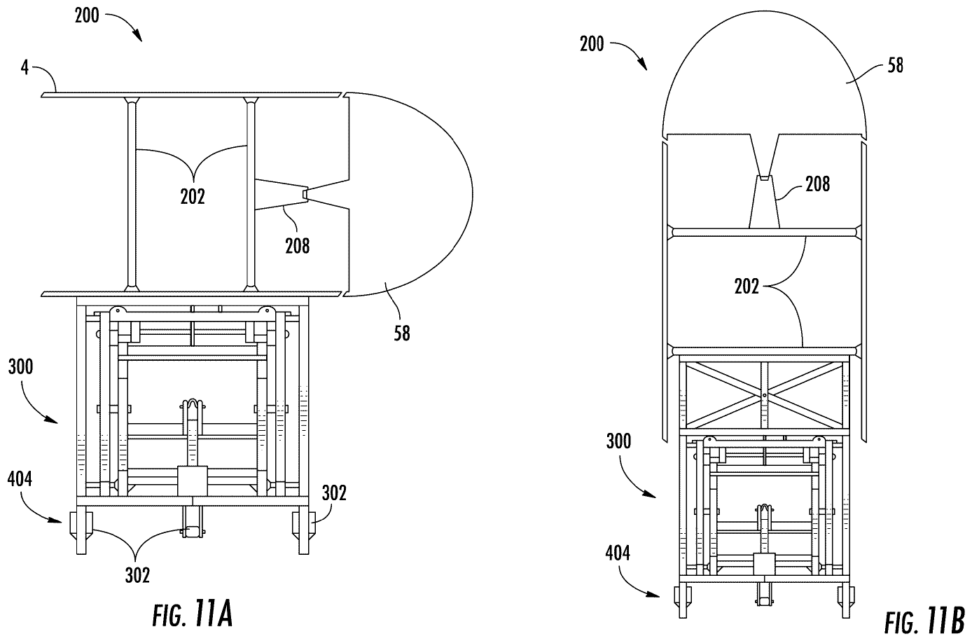

Referring now particularly to FIGS. 10A-10E, various embodiments of the locating features 208, 211 of the present disclosure are illustrated. For example, as shown in FIG. 10A, the locating feature(s) 208, 211 may include a locating plate 212 that can be secured to the spar structure 200 and/or the wind turbine blade segments 210 via one or more fasteners 216. In another embodiment, as shown in FIG. 10B, the locating feature(s) 208, 211 may include a groove 218 and a corresponding pin 220. In such embodiments, the groove 218 may be located on the spar structure 200 and the pin 220 may be located on the wind turbine blade segment 210 or vice versa. Further, in an embodiment, the groove 218 and pin 220 may be specifically shaped such that the groove 218 fits within the pin 220 and secures the wind turbine blade segment 210 to the spar structure 200.

As shown in FIG. 10C, the locating feature(s) 208, 211 may include a plate 224 that is incorporated and/or integral with the shear web 202 of the spar structure 200 and/or the wind turbine blade segment 210. In particular, as shown, the plate 224 may further include one or more fasteners 222, such as a staybolt for receiving the plate 224 therethrough. In such embodiments, the spar structure 200 or the wind turbine blade segment 210 may be secured to the plate 224.

As shown in FIG. 10D, in an embodiment, the locating feature(s) 208, 211 may include a chamfered recess 226 in which a corresponding protrusion of the spar structure 200 and/or the wind turbine blade segment 210 can be inserted. As shown in FIG. 10E, the locating feature(s) 208, 211 may include a first conical member 230 and a second conical member 232 sized to fit within the first conical member 230. In such embodiments, the first conical member 230 may be located on the spar structure 200 and second conical member 232 may be located on the wind turbine blade segment 210 or vice versa. Various other types of locating features may also be used, generally, such as grooves, protrusions, recesses, markings, indentations, or similar.

Referring now to FIGS. 11A-11B, various views of embodiments of the spar structure 200 described herein are illustrated. As shown, the spar structure 200 is secured to and supported by a fixture 300. Accordingly, in an embodiment, the fixture 300 is configured to move and/or elevate the spar structure 200 through an assembly line 402 (see e.g., FIG. 13). For example, as shown, the fixture 300 may include a conveyance device 404 for advancing the spar structure 200 through the assembly line 402. In an embodiment, for example, as shown in FIGS. 11A and 11B, the conveyance device 404 may be a plurality of rolling elements 302, such as rollers or wheels. In another embodiment, the conveyance device 404 may be a conveyor belt. In another embodiment,

In addition, as shown, the fixture 300 may include a moveable platform 304 configured to elevate and/or move the spar structure 200 thereon. In such embodiments, the moveable platform 304 can be useful in facilitating attachment of wind turbine blade segments to the spar structure 200 by providing improved access to the locating feature(s) 208, 211. For example, as shown in FIG. 11B, the fixture 300 may extend upwards to lift the spar structure 200 to a certain height.

In an embodiment, the spar structure 200 may be positioned on the fixture 300 in a variety of orientations. For example, as shown in FIG. 11A, the shear webs 202 of the spar structure 200 may be oriented vertically, and the bottom of the spar structure 200 may be placed on the fixture 300. As shown in FIG. 11B, the shear webs 202 may be oriented horizontally and one of the shear webs 202 may be placed on the fixture 300. The orientation of the spar structure 200 may be changed as needed while the spar structure 200 is being used to assemble a modular wind turbine blade as will be discussed hereinbelow.

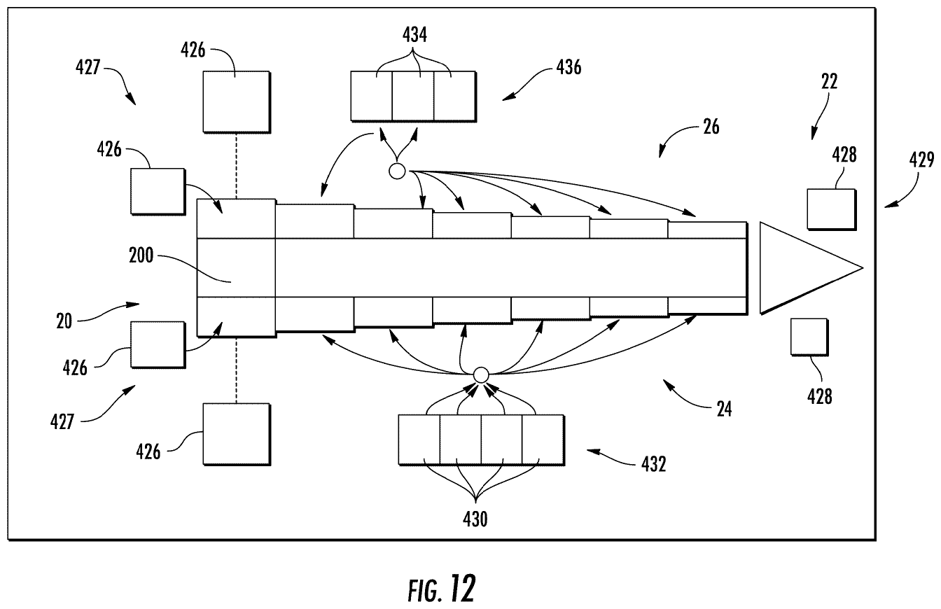

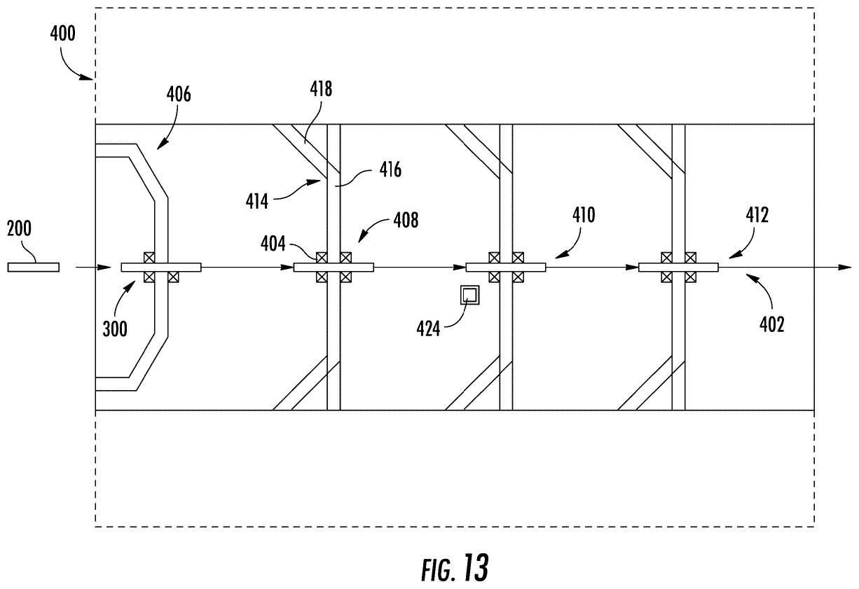

Referring now to FIG. 12, a top view of an embodiment of components for assembling the modular wind turbine blade 16 according to the present disclosure is illustrated. In particular, as shown, the wind turbine blade 16 may be constructed from a plurality of different subsets 427, 429, 432, 436 of wind turbine blade segments assembled onto the spar structure 200. More specifically, as shown, the subsets 427, 429, 432, 436 of the wind turbine blade segments 210 may include one or more blade root segments 426, one or more blade tip segments 428, one or more trailing edge segments 430, one or more leading edge segments 434, respectively, and/or combinations thereof. For example, in an embodiment, the subset of blade root segments 426 may be joined together prior to being secured to the spar structure 200 to form the blade root section 20 of the wind turbine blade 16. The joined blade root segments 426 may then be secured to the spar structure 200 to form the blade root section 20. A similar process can be repeated for each of the subsets as needed to assemble the different areas of the wind turbine blade 16. In such embodiments, the plurality of subsets 427, 429, 432, 436 of the wind turbine blade segments 210 may be secured to the spar structure 200, e.g., using bonding, fasteners, etc., to form the wind turbine blade 16.

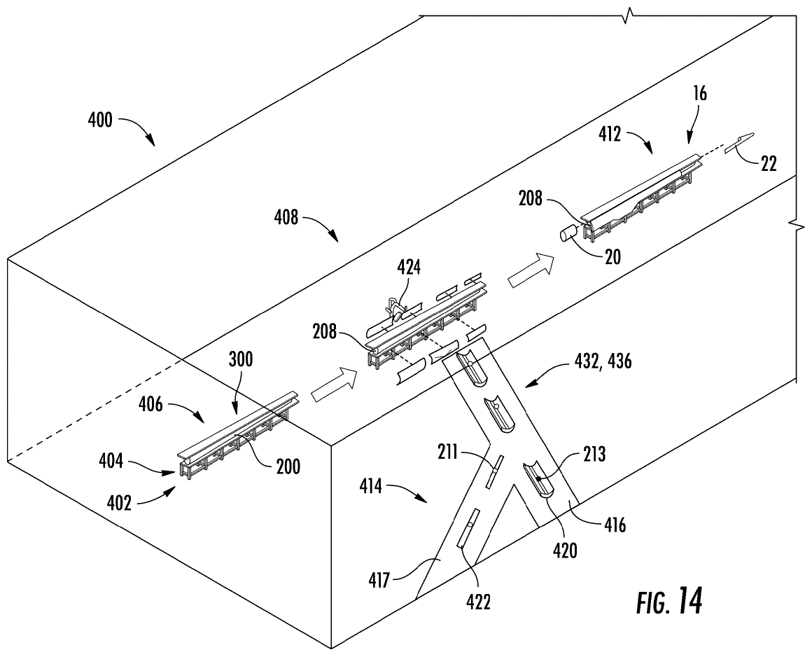

Referring now to FIGS. 13 and 14, various views of a manufacturing facility 400 for manufacturing and assembling wind turbine blades according to the present disclosure are illustrated. For example, as shown, the manufacturing facility 400 may include an assembly line 402. In particular, as shown, the assembly line 402 may include a plurality of stations 406, 408, 410, 412 arranged in a sequential manner for assembling the wind turbine blade 16. Such stations may include, for example, a first station 406, a second station 408, a third station 410, and a fourth station 412. However, it should be understood that any suitable number of stations may be included in the assembly line 402 including more than four or less than four stations.

More specifically, in an embodiment, each of the stations 406, 408, 410, 412 may include a different subset (e.g., any of subsets 427, 429, 432, 436) of the one or more wind turbine blade segments 210 for positioning onto the load-bearing spar structure 200. Thus, in an embodiment, the different subsets 427, 429, 432, 436 of the wind turbine blade segments 210 can be assembled and secured onto the spar structure 200 at each of the stations 406, 408, 410, 412 as the spar structure 200 moves along the assembly line 402. Moreover, in an embodiment, the assembly line 402 may include one or more supply lines 414 for feeding the subsets 427, 429, 432, 436 of the wind turbine blade segments 210 into the assembly line 402.

In an embodiment, for example, the spar structure 200 may be moved to the first station 406 via the conveyance device 404, or the spar structure 200 may be manually placed on the conveyance device 404 at the first station 406.

Accordingly, in an embodiment, the conveyance device 404 may be operated in a continuous or discontinuous manner. For example, in an embodiment, the conveyance device 404 may be operated to continuously move the spar structure 200 through the assembly line 402, e.g., using a conveyor belt, as the wind turbine blade 16 is being assembled. Moreover, in an embodiment, if the conveyance device 404 is continuously operated, the spar structure 200 may continuously advance through each of the stations 406, 408, 410, 412 while the wind turbine blade segments 210 are continuously attached to the spar structure 200. In alternative embodiments, the conveyance device 404 may be stopped and started at each station manually (e.g., using the roller elements 302) or automatically (e.g., using a controller that controls the conveyance device 404). In particular, in an embodiment, the conveyance device 404 may be pulsed through the assembly line 402 such that the spar structure 200 pauses at each of the stations 406, 408, 410, 412 for the wind turbine blade segments 210 to be attached to the spar structure 200. In another embodiment, the conveyance device 404 may also be pulsed through some of the stations 406, 408, 410, 412 while being continuously moved through the remaining stations 406, 408, 410, 412.

Still referring to FIGS. 13 and 14, in an embodiment, at the first station 406, the locating feature(s) 208 may be attached to the spar structure 200 to prepare the spar structure 200 for attachment of the wind turbine blade segments 210 described herein. In another embodiment, the spar structure 200 may be formed with the locating feature(s) 208 being integral therewith. Moreover, in an embodiment, a first subset 427 of the wind turbine blade segments 210 may be secured to the spar structure 200 at the first station 406 of the assembly line 402. For example, in an embodiment, the first subset 427 of the wind turbine blade segments may include, at least, the one or more blade root segments 426 used to form the blade root section 20 of the wind turbine blade 16. Thus, in an embodiment, the blade root section 20 may be placed onto the spar structure 200 at the first station 406 and secured thereto.

As shown at one or more intermediate stations (such as the second station 408 and the third station 410), second and third intermediate subsets 432, 436 of wind turbine blade segments, respectively, may be secured to the spar structure 200. For example, in an embodiment, the second and third intermediate subsets 432, 436 of the wind turbine blade segments may include, at least, one or more trailing edge segments 430, one or more leading edge segments 434, pressure side segments, suction side segments, and/or combinations thereof.

Thus, as shown particularly in FIG. 14, at the second station 408, the supply line 416, 418 may convey a subset of wind turbine blade segments, such as second and third intermediate subsets 432, 436 discussed above to the spar structure 200. Furthermore, as shown, the second and third intermediate subsets 432, 436 of wind turbine blade segments may be made up of different segments that can be joined together and then secured to the spar structure 200. For example, the second and third intermediate subsets 432, 436 of wind turbine blade segments may include first segments 420 and different, second segments 422 secured to each other to form the intermediate subsets 432, 436. In addition, the first and second segments 420, 422 may include locating features 211, 213 to assist in either securing to each other to form the intermediate subsets 432, 436 or to the spar structure 200 to form the wind turbine blade 16.

Further, as shown, the second station 408 may include one or more of the supply lines 414 configured to supply one or more of the wind turbine blade segments 210 or subsets into the assembly line 402. For example, the supply line(s) 414 may supply a wind turbine blade segment or subset of wind turbine blade segments from an area outside the manufacturing facility 400 to an area adjacent to the spar structure 200 on the assembly line 402 for assembly and securement thereto. For example, in an embodiment, the supply line(s) 414 may also include a conveyor belt or similar. Moreover, as shown in FIG. 13, the supply line(s) 414 may include one or more supply line branches 416, 418. Though FIG. 13 illustrates two supply line branches 416, 418, it should be understood that any number of supply line branches 416, 418 may be used depending on the wind turbine blade segment and/or subsets of wind turbine blade segments to be attached. The second and third intermediate subsets 432, 436 of the wind turbine blade segments can then be secured to the spar structure 200.

Moreover, in an embodiment, as shown in FIGS. 13 and 14, the spar structure 200 may be conveyed through the assembly line 402 to an end station, such as the fourth station 412. Further, in an embodiment, a fourth subset 429 of the wind turbine blade segments may be secured to the spar structure 200 at the fourth station 412 of the assembly line 402. For example, in an embodiment, as shown in FIG. 14, the fourth subset 429 of the wind turbine blade segments may include, at least, one or more blade tip segments 428 (FIG. 12). Moreover, as shown in FIG. 13, the fourth station 412 may also include one or more supply lines 414. Thus, at the fourth station 412, the blade tip segment(s) 428 may be assembled and secured to the spar structure 200 to complete the wind turbine blade 16, e.g., using one or more adhesives, fasteners, or any other suitable means.

Referring particularly to FIG. 14, a crane 424 may be utilized to position the wind turbine blade segments onto the spar structure 200 at the locating features 208 of the spar structure 200. In particular, the crane 424 may assist in assembling the wind turbine blade segments or subsets of wind turbine blade segments onto the spar structure 200. Other methods may also be used to assemble the wind turbine blade segments or subsets of wind turbine blade segments on the spar structure 200. For example, an operator, a robotic arm, or similar means may also be used in the assembly.

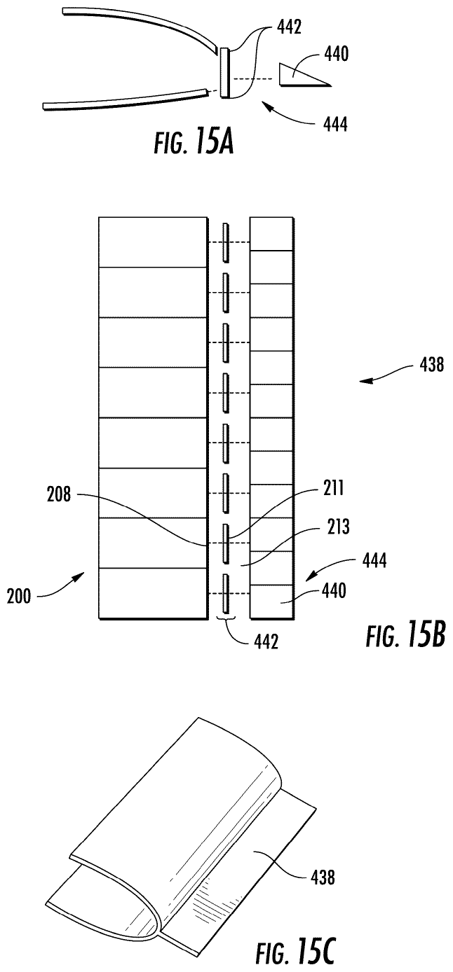

Referring now to FIGS. 15A-15C, various views of a fairing and methods for assembling same to a wind turbine blade according to the present disclosure are illustrated. In particular, FIGS. 15A and 15B illustrate various views of a fairing 438 according to the present disclosure. FIG. 15C illustrates a top view of the fairing 438 being assembled onto the spar structure 200 according to the present disclosure. As shown in FIG. 15A, the fairing 438 may include aerodynamic surfaces 442 and a trailing edge portion 440. Together, the aerodynamic surfaces 442 and the trailing edge portions 440 may form an additional subset 444. Further, as shown in FIG. 15C, one or more of the locating feature(s) 211 described herein may be included on the aerodynamic surface(s) 442. Thus, in an embodiment, the fairing 438 may be secured to the spar structure 200 via the locating feature(s) 208, 211. Similar to the fairing 438, other aerodynamic features may be assembled into additional subsets and secured to the spar structure 200. For example, in addition to fairing 438, the aerodynamic features may include vortex generators, fences, or similar.

Various aspects and embodiments of the present invention are defined by the following numbered clauses:
Clause 1. A method of assembling a wind turbine blade, the method comprising:
   providing a load-bearing spar structure having one or more locating features for locating one or more wind turbine blade segments, the load-bearing spar structure being secured to a fixture, the fixture being moveable and extendable;
   at least one of moving and extending the fixture so as to at least one of move and elevate the load-bearing spar structure through an assembly line;
   as the fixture is at least one of moved and extended through the assembly line, positioning the one or more wind turbine blade segments onto the one or more locating features of the load-bearing spar structure; and
   securing the one or more wind turbine blade segments to the load-bearing spar structure.
Clause 2. The method of clause 1, wherein the at least one of moving or extending of the fixture is accomplished via a conveyance device.
Clause 3. The method of clause 2, further comprising continuously operating the conveyance device through the assembly line to assemble the wind turbine blade.
Clause 4. The method of clause 2, further comprising pulsing the conveyance device through the assembly line to assemble the wind turbine blade.
Clause 5. The method of any of the preceding clauses, wherein the assembly line comprises a plurality of stations, each station comprising a different subset of the one or more wind turbine blade segments for positioning onto the load-bearing spar structure, the method further comprising: assembling subsets of the one or more wind turbine blade segments onto the load-bearing spar structure at the plurality of stations and securing the subsets of the one or more wind turbine blade to the spar structure at the plurality of stations.
Clause 6. The method of clause 5, further comprising:
feeding the subsets of the one or more wind turbine blade segments into the assembly line via one or more supply lines.
Clause 7. The method of clauses 5-6, wherein a first subset of the one or more wind turbine blade segments at a first station of the assembly line comprises, at least, a blade root section, the method further comprising positioning the blade root section onto the load-bearing spar structure at the first station.
Clause 8. The method of clauses 5-7, wherein one or more intermediate subsets of the one or more wind turbine blade segments at one or more intermediate stations of the assembly line comprises at least one of leading-edge segments, trailing edge segments, pressure side segments, or suction side segments, the method further comprising positioning the one or more intermediate subsets of the one or more wind turbine blade segments onto the load-bearing spar structure at the one or more intermediate stations.
Clause 9. The method of clauses 5-8, wherein an additional subset of the one or more wind turbine blade segments at an end station of the assembly line comprises, at least, a blade tip section, the method further comprising positioning the blade tip section onto the load-bearing spar structure at the end station.
Clause 10. The method of clause 9, wherein the additional subset of the one or more wind turbine blade segments at the end station of the assembly line comprises one or more aerodynamic blade features, the method further comprising positioning the one or more aerodynamic blade features onto the load-bearing spar structure at the end station.
Clause 11. The method of clause 10, wherein the one or more aerodynamic blade features comprise at least one of vortex generators, fairings, or fences.
Clause 12. The method of clauses 9-11, wherein securing the one or more wind turbine blade segments to the load-bearing spar structure further comprises bonding the one or more wind turbine blade segments to the load-bearing spar structure via one or more adhesives at the end station of the assembly line.
Clause 13. The method of any of the preceding clauses, wherein positioning the one or more wind turbine blade segments onto the one or more locating features of the load-bearing spar structure further comprises utilizing a crane to position one or more of the one or more wind turbine blade segments onto the one or more locating features of the load-bearing spar structure.
Clause 14. The method of any of the preceding clauses, wherein the one or more locating features comprise at least one of grooves, protrusions, recesses, markings, indentations, or combinations thereof.
Clause 15. The method of any of the preceding clauses, wherein the load-bearing spar structure comprises a first spar cap, a second spar cap, and a shear web arranged between the first and second spar caps.
Clause 16. The method of clause 15, wherein at least one location feature of the one or more locating features is positioned on the shear web.
Clause 17. A kit for assembling a wind turbine blade, the kit comprising:
   a load-bearing spar structure comprising one or more locating features;
   a fixture supporting the load-bearing spar structure, the fixture being moveable along at least one axis and extendable about at least one axis;
   an assembly line comprising a plurality of stations arranged along the at least one axis and a conveyance device secured to the fixture for moving the fixture to each of the plurality of stations along the at least one axis;
   one or more wind turbine blade segments attachable to the one or more locating features of the load-bearing spar structure, the one or more wind turbine blade segments comprising one or more subsets of wind turbine blade segments, at least one of the subsets of the wind turbine blade segments being placed at each of the plurality of stations; and
   a predetermined mapping for placing the one or more wind turbine blade segments onto the load-bearing spar structure, the predetermined mapping defining locations for each of the one or more wind turbine blade segments on the one or more locating features of the load-bearing spar structure.
Clause 18. The kit of clause 17, wherein the plurality of stations comprises a first station comprising a first subset of the one or more wind turbine blade segments, the first subset comprising, at least, a blade root section.
Clause 19. The kit of clause 18, wherein the plurality of stations comprises one or more intermediate stations comprising one or more intermediate subsets of the one or more wind turbine blade segments, the one or more intermediate subsets comprising at least one of leading-edge segments, trailing edge segments, pressure side segments, or suction side segments.
Clause 20. The kit of clause 19, wherein the plurality of stations comprises an end station comprising an additional subset of the one or more wind turbine blade segments, the end station comprising, at least, a blade tip section.

The skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of assembling a wind turbine blade, the method comprising:
providing a load-bearing spar structure having one or more locating features for locating one or more wind turbine blade segments, the load-bearing spar structure being secured to a fixture, the fixture being moveable and extendable;
at least one of moving and extending the fixture so as to at least one of move and elevate the load-bearing spar structure through an assembly line;
as the fixture is at least one of moved and extended through the assembly line, positioning the one or more wind turbine blade segments onto the one or more locating features of the load-bearing spar structure; and
securing the one or more wind turbine blade segments to the load-bearing spar structure.

2. The method of claim 1, wherein the at least one of moving or extending of the fixture is accomplished via a conveyance device.

3. The method of claim 2, further comprising continuously operating the conveyance device through the assembly line to assemble the wind turbine blade.

4. The method of claim 2, further comprising pulsing the conveyance device through the assembly line to assemble the wind turbine blade.

5. The method of claim 1, wherein the assembly line comprises a plurality of stations, each station comprising a different subset of the one or more wind turbine blade segments for positioning onto the load-bearing spar structure, the method further comprising: assembling subsets of the one or more wind turbine blade segments onto the load-bearing spar structure at the plurality of stations and securing the subsets of the one or more wind turbine blade to the spar structure at the plurality of stations.

6. The method of claim 5, further comprising:
feeding the subsets of the one or more wind turbine blade segments into the assembly line via one or more supply lines.

7. The method of claim 5, wherein a first subset of the one or more wind turbine blade segments at a first station of the assembly line comprises, at least, a blade root section, the method further comprising positioning the blade root section onto the load-bearing spar structure at the first station.

8. The method of claim 5, wherein one or more intermediate subsets of the one or more wind turbine blade segments at one or more intermediate stations of the assembly line comprises at least one of leading-edge segments, trailing edge segments, pressure side segments, or suction side segments, the method further comprising positioning the one or more intermediate subsets of the one or more wind turbine blade segments onto the load-bearing spar structure at the one or more intermediate stations.

9. The method of claim 5, wherein an additional subset of the one or more wind turbine blade segments at an end station of the assembly line comprises, at least, a blade tip section, the method further comprising positioning the blade tip section onto the load-bearing spar structure at the end station.

10. The method of claim 9, wherein the additional subset of the one or more wind turbine blade segments at the end station of the assembly line comprises one or more aerodynamic blade features, the method further comprising positioning the one or more aerodynamic blade features onto the load-bearing spar structure at the end station.

11. The method of claim 10, wherein the one or more aerodynamic blade features comprise at least one of vortex generators, fairings, or fences.

12. The method of claim 9, wherein securing the one or more wind turbine blade segments to the load-bearing spar structure further comprises bonding the one or more wind turbine blade segments to the load-bearing spar structure via one or more adhesives at the end station of the assembly line.

13. The method of claim 1, wherein positioning the one or more wind turbine blade segments onto the one or more locating features of the load-bearing spar structure further comprises utilizing a crane to position one or more of the one or more wind turbine blade segments onto the one or more locating features of the load-bearing spar structure.

14. The method of claim 1, wherein the one or more locating features comprise at least one of grooves, protrusions, recesses, markings, indentations, or combinations thereof.

15. The method of claim 1, wherein the load-bearing spar structure comprises a first spar cap, a second spar cap, and a shear web arranged between the first and second spar caps.

16. The method of claim 15, wherein at least one location feature of the one or more locating features is positioned on the shear web.

17. A kit for assembling a wind turbine blade, the kit comprising:
a load-bearing spar structure comprising one or more locating features;
a fixture supporting the load-bearing spar structure, the fixture being moveable along at least one axis and extendable about at least one axis;
an assembly line comprising a plurality of stations arranged along the at least one axis and a conveyance device secured to the fixture for moving the fixture to each of the plurality of stations along the at least one axis;
one or more wind turbine blade segments attachable to the one or more locating features of the load-bearing spar structure, the one or more wind turbine blade segments comprising one or more subsets of wind turbine blade segments, at least one of the subsets of the wind turbine blade segments being placed at each of the plurality of stations; and
a predetermined mapping for placing the one or more wind turbine blade segments onto the load-bearing spar structure, the predetermined mapping defining locations for each of the one or more wind turbine blade segments on the one or more locating features of the load-bearing spar structure.

18. The kit of claim 17, wherein the plurality of stations comprises a first station comprising a first subset of the one or more wind turbine blade segments, the first subset comprising, at least, a blade root section.

19. The kit of claim 18, wherein the plurality of stations comprises one or more intermediate stations comprising one or more intermediate subsets of the one or more wind turbine blade segments, the one or more intermediate subsets comprising at least one of leading-edge segments, trailing edge segments, pressure side segments, or suction side segments.

20. The kit of claim 19, wherein the plurality of stations comprises an end station comprising an additional subset of the one or more wind turbine blade segments, the end station comprising, at least, a blade tip section.
